(19) United States
(12) Patent Application Publication
(10) Pub. No.: US 2008/0132169 A1
(43) Pub. Date: Jun. 5, 2008

(54) Wireless communication system and wireless communication apparatus

(76) Inventor: Hirotaka MURAMATSU, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/903,679

(22) Filed: Sep. 24, 2007

(30) Foreign Application Priority Data
Oct. 2, 2006 (JP) 2006-270365

(51) Int. Cl. H04B 7/00

(52) U.S. Cl. 455/41.2

(57) ABSTRACT

A wireless communication system includes a terminal and a host. The terminal includes a reflector that receives an unmodulated carrier and transmits a modulated reflected wave on which data is superimposed. The host includes a reflected wave reader that reads data from the modulated reflected wave. The host periodically transmits a beacon frame and successively transmits an unmodulated carrier during an entry period that is provided after beacon frame transmission. Upon receipt of the beacon frame from the host, the terminal returns an entry frame that is superimposed on a reflected wave of the unmodulated carrier received during the entry period.

### CROSS REFERENCES TO RELATED APPLICATIONS

The present invention contains subject matter related to Japanese Patent Application JP 2006-270365 filed in the Japan Patent Office on Oct. 2, 2006, the entire contents of which being incorporated herein by reference.

### BACKGROUND OF THE INVENTION

1. Field of the Invention

The present invention relates to a wireless communication system and wireless communication apparatus that establish low-power-consumption communication between devices located at a relatively short distance from each other, and more particularly to a wireless communication system and wireless communication apparatus that provide data communication by a reflected wave transmission method, which uses the transmission of an unmodulated carrier from a reflected wave reader and the absorption and reflection of a received radio wave that are based on antenna termination at a transmitter.

More specifically, the present invention relates to a wireless communication system and wireless communication apparatus that establish one-to-one reflected wave communication while allowing a host having a reflected wave reader and a terminal having a reflector to respectively select a connection target, and more particularly to a wireless communication system and wireless communication apparatus that control communication connection and transmission/reception timing to ensure that no reflected wave transmission is interrupted by a host or terminal that is not engaged in communication.

2. Description of the Related Art

It is expected that a wireless communication technology will save the user the trouble of having to make cable connections for the use of a wired communication method. Therefore, the wireless communication technology is rapidly becoming widespread. The wireless communication technology relates to wireless communication that is provided, for instance, by PDC (Personal Digital Cellular), PHS (Personal Handyphone System), IEEE 802.11 for wireless LANs (Local Area Networks), or Bluetooth.

Further, a proposal has been recently made in relation to a data communication system based on a noncontact communication method, which is used, for instance, for an RFID (Radio Frequency IDentifier). Typical noncontact communication methods include an electrostatic coupling method, electromagnetic induction method, and radio wave communication method. An RFID system, which is based on the radio wave communication method, includes a reflector, which modulates a received unmodulated carrier and transmits data by using a reflected wave derived from modulation; and a reflected wave reader, which reads data from a modulated reflected wave signal from the reflector. The RFID system provides reflected wave transmission called “backscatter.”

When an unmodulated carrier is transmitted from the reflected wave reader, the reflector modulates a reflected wave of the unmodulated carrier to superimpose data in accordance, for instance, with an antenna load impedance changeover procedure. Since no carrier generation source is necessary for the reflector, a data transmission operation can be carried out at low power consumption. An antenna switch for changing the load impedance of an antenna generally includes a gallium arsenide (GaAs) IC (Integrated Circuit) and has a power consumption of not higher than several tens of microwatts. Meanwhile, wireless LANs consume a power of several hundreds of milliwatts to several watts for communication. It can therefore be said that reflected wave communication exhibits an overwhelming performance advantage over ordinary wireless LAN communication whose average power consumption is relatively high (refer, for instance, to Japanese Patent Laid-Open No. 2005-64822).

Since a terminal having the reflector merely reflects a received radio wave, it is not regarded as a radio station and not subject to legal restrictions on radio wave communication. Further, a noncontact communication system based, for instance, on the electromagnetic induction method uses a frequency of several megahertz to several hundred megahertz. On the other hand, the use of a reflected wave communication method makes it possible to achieve high-speed data transmission by using a high-frequency band as high as 2.4 GHz, which is called an ISM (Industrial, Scientific, and Medical) band.

For example, the reflector can be built in a digital camera, video camera, cellular phone, mobile information terminal, portable audio player, or other mobile terminal device whose power consumption should be minimized. Further, the reflected wave reader can be built in a television, monitor, printer, PC, VTR, DVD player, or other host device that includes, for instance, a stationary home electric appliance. Consequently, image data picked up by a camera-equipped cellular phone or digital camera can be uploaded to a PC via a reflected wave transmission path and stored, displayed, printed out, or otherwise used.

FIG. 12 shows a typical implementation of a wireless communication system based on reflected wave transmission. In this system, a plurality of terminals having the reflector issue a data transmission request to a host having the reflected wave reader. FIG. 13 shows another typical implementation in which a terminal having the reflector issues a data transmission request to one of a plurality of hosts having the reflected wave reader.

In the example shown in FIG. 12 in which two terminals are positioned near a host, the host acquires data from either of the two terminals when the user operates the host by manipulating an infrared remote controller or by pressing a button on the host. This data transmission can be referred to as a “pull transmission” because data is read from a terminal in accordance with a request from the host. In the example shown in FIG. 13 in which a terminal is readily accessible to the user and positioned at a certain distance from each host, the user directly operates the terminal to specify a destination host and transmit data to it. This data transmission can be referred to as a “push transmission” because data is transferred to a host in accordance with a request from the terminal.

If individual hosts and terminals do not exercise transmission/reception timing control when a reflected wave is transmitted in an environment in which a plurality of hosts or terminals exist as shown in FIG. 12 or 13, a frame transmitted from a certain host or terminal may interrupt the communication of another host or terminal, thereby making it difficult to transmit data. Therefore, the wireless communication function of the reflector of a terminal and the reflected wave reader of a host needs to exercise timing control over communication connection and transmission/reception to ensure that hosts or terminals not engaged in communication do not interrupt another reflected wave transmission.

A technology for incorporating a wireless communication device, which includes a reflector, in a memory card for insertion, for instance, into a digital camera is proposed (refer, for instance, to Japanese Patent Laid-Open No. 2006-216011). The digital camera can read and write image data via a connector interface of the memory card while a PC or other external host can read image data from the memory card via a wireless communication device, which includes a reflected wave reader, by means of reflected wave transmission. In this instance, the digital camera into which the memory card is inserted may not recognize the communication status of reflected wave transmission and may not exercise timing control over communication connection and transmission/reception to/from the external host in a reflected wave transmission path. In other words, the reflector in the terminal, that is, in the memory card, needs to autonomously exercise timing control over transmission/reception to/from the external host.

### SUMMARY OF THE INVENTION

There is a need for an excellent wireless communication system and wireless communication apparatus that can achieve proper data communication by a reflected wave transmission method, which uses the transmission of an unmodulated carrier from a reflected wave reader and the absorption and reflection of a received radio wave that are based on antenna termination at a transmitter.

There is another need for an excellent wireless communication system and wireless communication apparatus that can properly establish one-to-one reflected wave communication while allowing a host having a reflected wave reader and a terminal having a reflector to respectively select a connection target.

There is still another need for an excellent wireless communication system and wireless communication apparatus that can provide proper system operations by controlling communication connection and transmission/reception timing to ensure that no reflected wave transmission is interrupted by a host or terminal that is not engaged in communication.

The present invention has been made in view of the above circumstances. According to an embodiment of the present invention, there is provided a wireless communication system including a terminal and a host. The terminal includes a reflector that receives an unmodulated carrier and transmits a modulated reflected wave on which data is superimposed. The host includes a reflected wave reader that reads data from the modulated reflected wave. The host periodically transmits a beacon frame and successively transmits an unmodulated carrier during an entry period that is provided after beacon frame transmission. Upon receipt of the beacon frame from the host, the terminal returns an entry frame that is superimposed on a reflected wave of the unmodulated carrier received during the entry period.

The term “system,” which is used in this document, refers to a logical aggregate of a plurality of devices (or functional modules performing specific functions). The term “system” is used no matter whether the devices and functional modules are within the same housing.

The present invention relates to a wireless communication system that uses a radio wave reflection technology and includes a terminal having a reflector for receiving an unmodulated carrier and transmits a modulated reflected wave on which data is superimposed and a host having a reflected wave reader that reads data from the modulated reflected wave. Since the reflector in this communication system does not need a carrier generation source, data transmission can be achieved with the power consumption dramatically reduced. This communication system exhibits an overwhelming performance advantage over ordinary wireless LANs. Further, the use of a high-frequency band as high as 2.4 GHz, which is called an ISM band, makes it possible to achieve data transmission at a far higher speed than the use of another noncontact communication system based, for instance, on the electromagnetic induction method.

In the wireless communication system according to an embodiment of the present invention, the host and terminal are provided with a service entry sequence for recognizing a remote station ready for communication. Within this sequence, the host intermittently transmits a beacon frame at fixed time intervals. Meanwhile, when the terminal is within a radio wave reception range and receives the beacon frame, the terminal acquires information about the host from the information contained in the beacon frame. If the terminal intends to connect to the host, the terminal returns an entry frame, which is superimposed on a reflection of an unmodulated carrier, by making use of an entry period. In this manner, the host and terminal can recognize one or more remote stations ready for communication.

The host acquires information about the terminal in accordance with the information contained in the entry frame and transmits a connection request frame to the terminal to be connected. When the terminal intends to answer a connection request contained in the connection request frame, the terminal returns a connection response frame whose payload includes a connection result and other information. The connection is then established so that data can be transferred between the host and terminal.

A pull transmission and a push transmission can be cited as typical implementations of the wireless communication system based on reflected wave transmission. The pull transmission is performed to read data from a terminal in accordance with a request from a host. The push transmission is performed to transfer data to a host in accordance with a request from a terminal.

However, if individual hosts and terminals do not exercise transmission/reception timing control when a reflected wave is transmitted in an environment in which a plurality of hosts or terminals exist, a frame transmitted from a certain host or terminal may interrupt the communication of another host or terminal, thereby making it difficult to transmit data. Therefore, the wireless communication function of, for instance, the reflector of a terminal and the reflected wave reader of a host needs to exercise timing control over communication connection and transmission/reception to ensure that hosts and terminals not engaged in communication do not interrupt another reflected wave transmission. Particularly, the terminals having the reflector need to autonomously exercise timing control over transmission/reception to/from the hosts.

Under the above circumstances, the wireless communication system according to an embodiment of the present invention incorporates a function for performing a carrier sense before the start of beacon frame transmission from a host for the purpose of exercising control so as not to interrupt the other hosts and terminals engaged in communication by initiating a beacon frame transmission on an idle communication frequency channel.

If a plurality of terminals can receive the beacon frame transmitted from a certain host, entry frames transmitted from the terminals may collide with each other. Therefore, the terminals incorporate a function for returning an entry frame with random timing in order to reduce the probability with which a plurality of terminals simultaneously transmit an entry frame and decrease the risk of collision.

When a host that has failed to receive an entry frame and is not chosen as a connection target recognizes that the communication channel has become busy due to the communication between another host and a terminal in a carrier sense before beacon frame transmission, the host stops the transmission of a beacon frame. A terminal that is not chosen as a connection target by a host loses an opportunity of transmitting an entry frame and does not interrupt the other terminals and hosts engaged in communication because a host that has started communicating with another terminal stops the transmission of a beacon frame.

When a host finishes the communication with a certain terminal and initiates the service entry sequence again to connect to another terminal, the terminal to be selected as a new connection destination has to constantly wait until the service entry sequence resumes, thereby wasting electrical power.

Under the above circumstances, the host may incorporate a function for periodically transmitting a busy beacon, which indicates that the host is engaged in communication, while communicating with a certain terminal. A terminal not communicating with the host may incorporate a function for waiting to receive a busy beacon at intervals in accordance with interval information contained in a received busy beacon, thereby reducing the power consumption for waiting to receive the busy beacon.

A terminal having the reflector needs to receive a beacon frame and autonomously exercise timing control over transmission/reception to/from the host. The terminal can additionally incorporate an extended control function such as a “multiple beacon reception function,” “single beacon reception function,” or “specified beacon reception function.” The multiple beacon reception function is exercised to receive all beacon frames transmitted from a plurality of hosts. The single beacon reception function is exercised to synchronize with a host from which the first beacon frame was received and subsequently receive only the beacon frame from that host. The specified beacon reception function is exercised to receive only the beacon frame from a preregistered host.

In a communication environment in which a push transmission is performed, for example, the terminal can incorporate the multiple beacon reception function to notify the user of a plurality of hosts from which the beacon frame was received, and allow the user to select which host to communicate with. Further, the terminal can incorporate the single beacon reception function without confirming the user's intention to autonomously synchronize with a host from which the first beacon frame was received. Furthermore, the terminal can incorporate the specified beacon reception function to exercise a simplified security function.

In the service entry sequence, the host receives an entry frame to recognize a terminal that is ready for communication. In a pull transmission, the user may operate the host to select the terminal to be connected. In a push transmission, on the other hand, the user may operate the terminal to issue a connection request to the host.

The present invention makes it possible to provide an excellent wireless communication system and wireless communication apparatus that can properly establish one-to-one reflected wave communication while allowing a host having a reflected wave reader and a terminal having a reflector to respectively select a connection target.

The present invention also makes it possible to provide an excellent wireless communication system and wireless communication apparatus that can provide proper system operations by controlling communication connection and transmission/reception timing to ensure that no reflected wave transmission is interrupted by a host or terminal that is not engaged in communication.

In the wireless communication system according to an embodiment of the present invention, the host and terminal are provided with a service entry sequence for recognizing a remote station ready for communication. The host performs a carrier sense when transmitting a beacon frame or connection request frame, and transmits a busy beacon while it is connected to a terminal. Meanwhile, the terminal arbitrarily sets up reception conditions for waiting for a beacon, and transmits an entry frame with one of a plurality of transmission slots randomly selected. Further, the terminal also transmits a transmission-request-attached entry frame for notifying the host that there is transmission data.

Consequently, the wireless communication system according to an embodiment of the present invention enables the host and terminal to select one of a plurality of remote stations as a connection target and establish one-to-one communication while decreasing the risk of beacon frame collision between a plurality of hosts and the risk of entry frame collision between a plurality of terminals. Further, the wireless communication system can exercise control so that an unconnected host and terminal do not interrupt the communication between a connected host and terminal.

Furthermore, when the terminal has a function for receiving a beacon frame that matches a particular type of data communication, the terminal can be accessed by only an appropriate host. In other words, it is possible to establish a connection from a host or from a terminal depending on the type of transmission such as a pull transmission or a push transmission.

When, for instance, a terminal is in an environment in which the terminal can perform a push transmission to communicate with a plurality of hosts, the terminal can exercise the multiple beacon reception function to receive a beacon frame from the plurality of hosts, notify the user of the presence of the plurality of hosts, and let the user select a host to communicate with.

If the terminal does not have a user interface for letting the user select one of the plurality of hosts from which the beacon frame was received, the terminal exercises the single beacon reception function without confirming the user's intention to autonomously synchronize with a host from which the first beacon frame was received.

In addition, the terminal can incorporate the specified beacon reception function to exercise a simplified security function. For example, the terminal having the specified beacon reception function synchronizes with only a beacon frame received from a preregistered host and is not allowed to communicate with an unregistered host. Consequently, the use of this function ensures that the data retained by the terminal is not unduly accessed by an unspecified host.

Other features and advantages of the present invention will become more apparent from the following detailed description of embodiments of the present invention and from the accompanying drawings.

### BRIEF DESCRIPTION OF THE DRAWINGS

FIG. 1A shows the configuration of a wireless communication apparatus that operates as a terminal within a wireless communication system based on a reflected wave transmission method;

FIG. 1B shows the configuration of a wireless communication apparatus that operates as a host within a wireless communication system based on a reflected wave transmission method;

FIG. 2 shows an example of a service entry sequence;

FIG. 3 shows a sequence that is followed when the host and terminal initiate a communication operation by using the service entry sequence shown in FIG. 2;

FIG. 4 shows a sequence that is followed when a communication operation is aborted;

FIG. 5 shows a sequence that is followed when the host terminates a communication operation on its own initiative;

FIG. 6 shows a sequence that is followed when the terminal terminates a communication operation on its own initiative;

FIG. 7 shows an example of a frame format that is used in communication sequences shown in FIGS. 3 to 6;

FIG. 8 is a flowchart illustrating processing steps that the host performs to control the service entry sequence;

FIG. 9 is a flowchart illustrating processing steps that the host performs to exercise carrier sense control;

FIG. 10 is a flowchart illustrating processing steps that the terminal performs to control the service entry sequence;

FIG. 11 shows a typical frame exchange sequence that is followed when the host communicating with the terminal uses a function for periodically transmitting a busy beacon for announcement purposes;

FIG. 12 shows a typical implementation of the wireless communication system based on reflected wave transmission; and

FIG. 13 shows another typical implementation of the wireless communication system based on reflected wave transmission.

### DETAILED DESCRIPTION OF THE PREFERRED EMBODIMENTS

Embodiments of the present invention will now be described in detail with reference to the accompanying drawings.

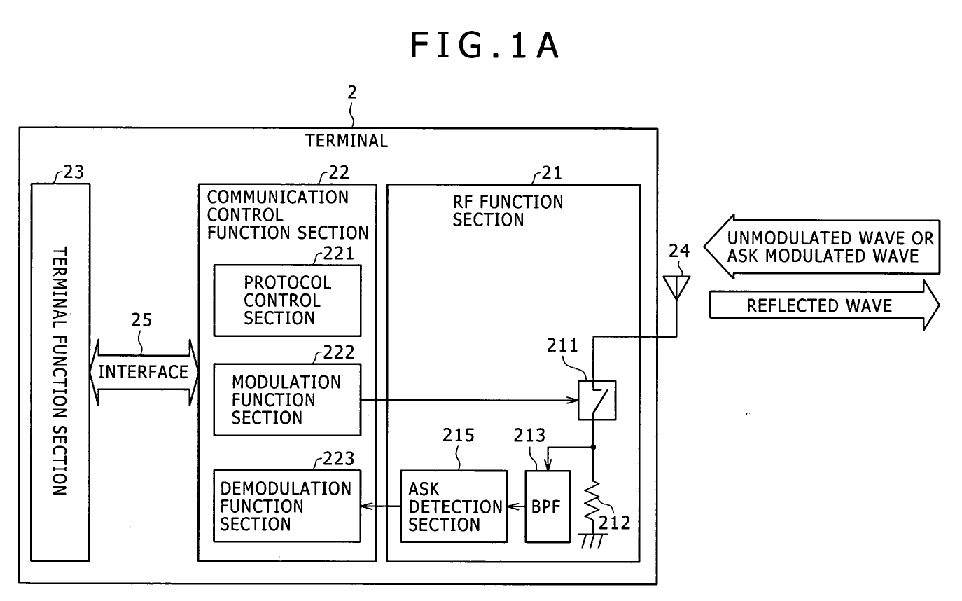

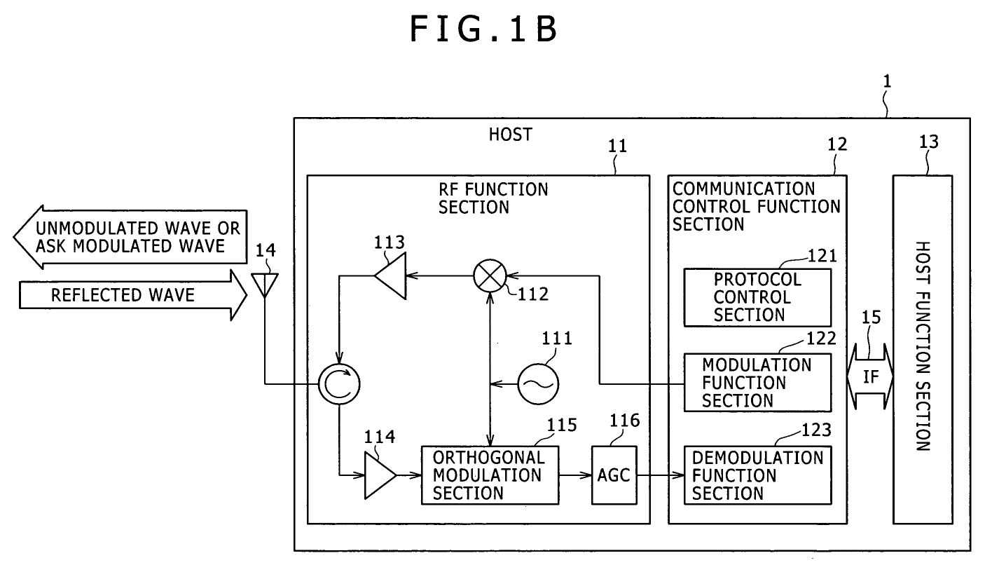

FIGS. 1A and 1B show the configuration of a wireless communication apparatus that operates as a terminal or host within a wireless communication system based on a reflected wave transmission method.

In the host 1, transmission data generated in a host function section 13 is transferred via a control interface 15 and modulated by a modulation function section 122 in a host communication control function section 12. The resulting modulated signal is placed on a carrier wave generated by a carrier generation source 111 in an RF function section 11 and transmitted from an antenna 14 to a terminal 2. An RF function section 21 of the terminal 2 receives the modulated wave and acquires a demodulated signal. The demodulated signal is subjected to data demodulation by a demodulation function section 223 in a terminal communication control function section 22. The resulting data is then received by a terminal function section 23 via a control interface 25. The terminal function section 23 stores or displays the received data, notifies the user of the received data, or otherwise handles the received data as occasion demands.

Meanwhile, the data generated by the terminal function section 23 of the terminal 2 is modulated by a modulation function section 222 in the communication control function section 22. The resulting modulated signal is placed on a reflected wave that is obtained when the RF function section 21 detects a carrier wave, and transmitted from an antenna 24 to the host 1 as a modulated reflected wave signal. The RF function section 11 of the host 1 obtains a demodulated signal from a reflected wave that is received by the antenna 14. The demodulated signal is subjected to data demodulation by a demodulation function section 123 and received by the host function section 13 via the control interface 15. The host function section 13 stores or displays the received data, notifies the user of the received data, or otherwise handles the received data as occasion demands.

Further, protocol control sections 121, 221, which mutually function in relation to the host 1 and terminal 2, are added to the communication control function sections 12, 22. Consequently, a protocol control function, for instance, for exercising connection/disconnection control between the host 1 and terminal 2 is provided in addition to the data transmission/reception function described above. The protocol control sections 121, 221 cooperatively operate to perform a service entry sequence and a sequence for communication connection, data exchange, and communication disconnection. These communication sequences will be described in detail later.

In the wireless communication system according to the present embodiment, no carrier generation source is necessary for the RF function section 21 of the terminal 2. Therefore, the system can be driven at low power consumption. Further, high-speed communication can be provided in a terminal-to-host direction (uplink direction) by causing the terminal 2 to provide multilevel modulation. Here, the host 1 performs ASK modulation in consideration for ease of detection in the terminal 2. Consequently, a low data rate prevails in a host-to-terminal direction (downlink direction).

For example, a reflector can be built in a digital camera, video camera, cellular phone, mobile information terminal, portable audio player, or other mobile terminal 2 whose power consumption should be minimized. Further, a reflected wave reader can be built in a television, monitor, printer, PC, VTR, DVD player, or other host 1 that includes, for instance, a stationary home electric appliance. Consequently, image data picked up by a camera-equipped cellular phone or digital camera can be uploaded to a PC via a reflected wave transmission path and stored, displayed, printed out, or otherwise used.

In the wireless communication system according to the present embodiment, the host 1 and terminal 2 are provided with a function for controlling their transmission/reception timing. Therefore, even when a plurality of hosts or terminals exist, it is possible to provide smooth communication without being affected by the type of transmission or the form of terminal implementation.

In the wireless communication system according to the present embodiment, the host and terminal have a service entry sequence as a communication procedure for recognizing the existence of each other. In the service entry sequence, the host transmits a beacon frame at fixed intervals to announce its service area. Meanwhile, the terminal receives the beacon frame to become aware of the existence of the host and returns an entry frame to the host. The host receives the entry frame from the terminal and becomes aware of the existence of the terminal that is ready for communication. In this manner, the host and terminal recognize the existence of one or more remote stations that are ready for communication.

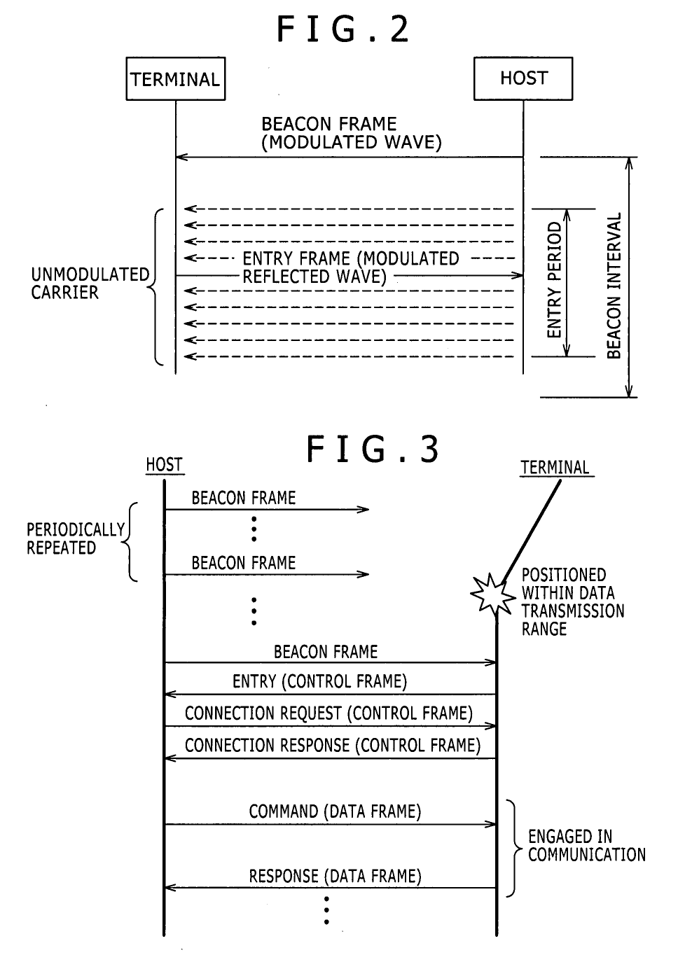

FIG. 2 shows a typical service entry sequence. The host periodically transmits a beacon frame. An entry period is provided after a beacon frame transmission. The host successively transmits an unmodulated carrier during the entry period. A terminal that is positioned within a region for receiving the beacon frame from the host can return an entry frame by superimposing it on a reflected wave of the unmodulated carrier received during the entry period.

A normal reflected wave transmission procedure based on beacon/entry frame exchange will now be described.

FIG. 3 shows a sequence that is followed when the host and terminal initiate a communication operation by using the service entry sequence shown in FIG. 2.

The host intermittently transmits a beacon frame at fixed time intervals. The terminal may not receive the beacon frame while it is outside a radio wave reception range. However, when the terminal moves into the radio wave reception range and the beacon frame arrives, it performs a process for receiving the beacon frame.

In accordance with host information that is included in a payload of the received beacon frame, the terminal acquires the information about the communication frequency channel to be used, the host's unique ID, and the like. When the terminal intends to connect to the host, it returns an entry frame by superimposing it on the reflected wave of the unmodulated carrier by making use of the entry period.

In accordance with the contents of the entry frame, the host acquires the unique ID of the terminal, settable communication parameters, and other information. When the host intends to communicate with the terminal, it transmits a connection request frame whose payload includes the communication parameters and other relevant information. When the terminal answers a connection request that is contained in the connection request frame, it returns a connection response frame whose payload includes a connection result and other information. This establishes a connection. While the connection is established, the host repeatedly transmits a command frame and the terminal repeatedly returns a response frame in response to the command frame.

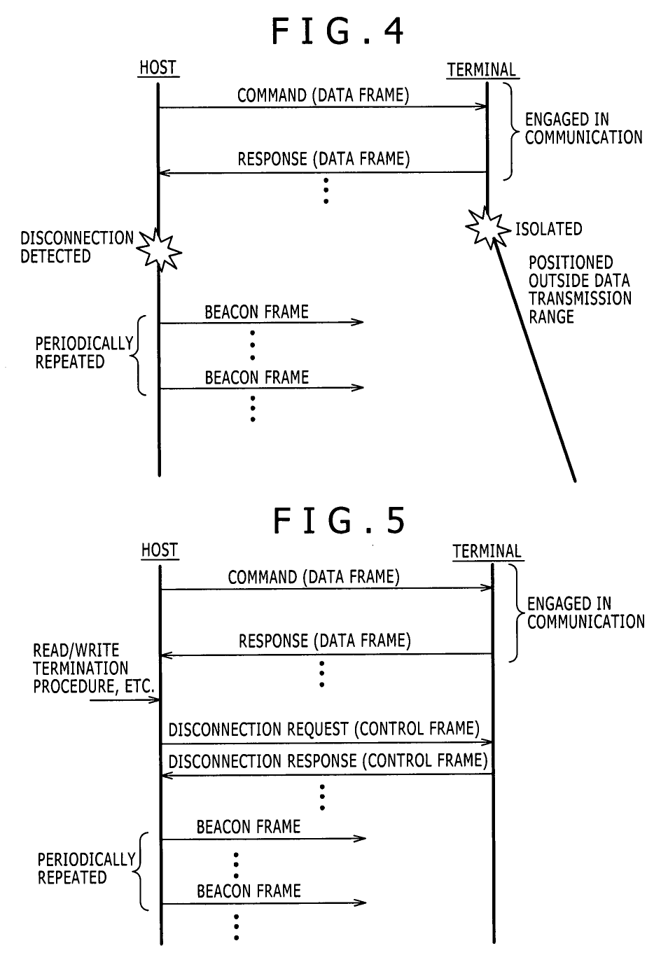

Even when reflected wave communication is in progress, the communication operation may suddenly abort if the terminal is isolated from the host or an obstacle is placed between the terminal and host. FIG. 4 shows a sequence that is followed when the communication operation is aborted.

While the connection is established, the host repeatedly transmits a command frame and the terminal repeatedly returns a response frame in response to the command frame.

If the communication is broken off as the terminal is isolated from the host or otherwise positioned outside the radio wave reception range, the host can detect such a disconnection, for instance, because it has not received a response frame within a predefined period of time after its last command frame transmission. Subsequently, the host switches to a standby state and follows the service entry sequence (see FIG. 2) in which the host intermittently transmits a beacon frame at fixed time intervals.

Even if the terminal is positioned within a region for successful reflected wave transmission, the host can disconnect the terminal on its own initiative after reading data from the terminal. FIG. 5 shows a sequence that is followed when the host terminates a communication operation on its own initiative.

While the connection is established, the host repeatedly transmits a command frame and the terminal repeatedly returns a response frame in response to the command frame.

When the host finishes reading desired data from the terminal or intends to terminate its access to the terminal for some other reason, the host transmits a disconnection request frame whose payload includes information such as the reason for disconnection. In response to the disconnection request frame, the terminal returns a disconnection response frame whose payload includes information such as a disconnection result. This breaks the connection. Subsequently, the host switches to a standby state and follows the service entry sequence (see FIG. 2) in which the host intermittently transmits a beacon frame at fixed time intervals.

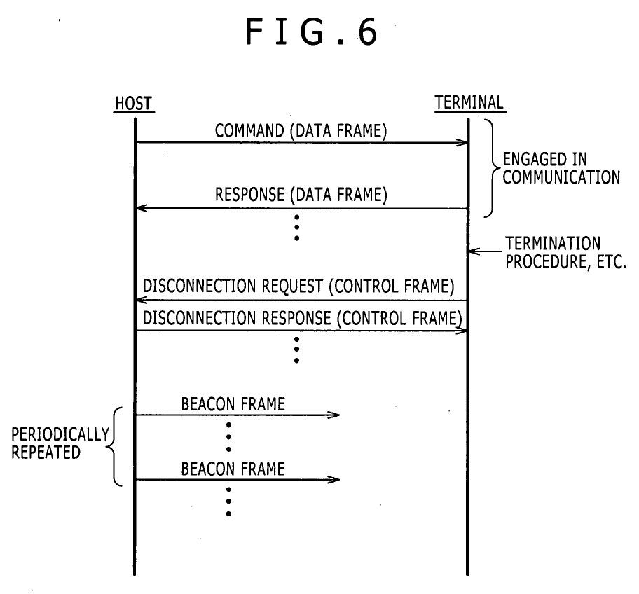

Meanwhile, the terminal may intend to finish its communication operation on its own initiative instead of allowing the host to take the initiative. The terminal can finish its communication operation on its own initiative when, for instance, a content push distribution from the terminal to the host terminates or the terminal finishes a pull distribution of content within the host. FIG. 6 shows a sequence that is followed when the terminal finishes its communication operation on its own initiative.

While the connection is established, the host repeatedly transmits a command frame and the terminal repeatedly returns a response frame in response to the command frame.

When the terminal finishes transmitting desired data or intends to finish communicating with the host for some other reason, the terminal transmits a disconnection request frame whose payload includes information such as the reason for disconnection. In response to the disconnection request frame, the host returns a disconnection response frame whose payload includes information such as a disconnection result. This breaks the connection. Subsequently, the host switches to a standby state and follows the service entry sequence (see FIG. 2) in which the host intermittently transmits a beacon frame at fixed time intervals.

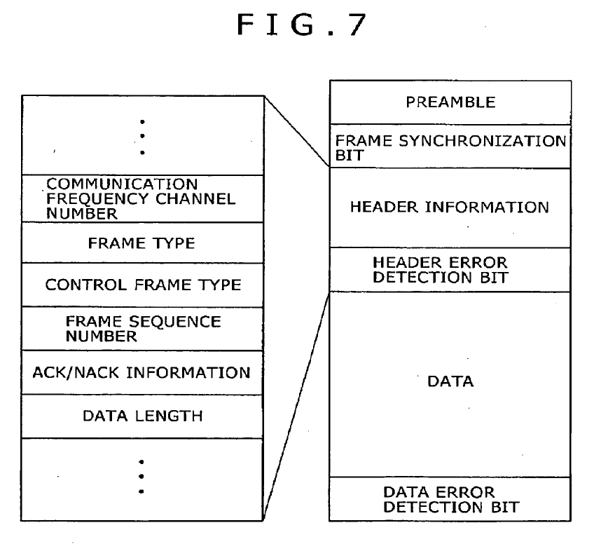

FIG. 7 shows an example of a frame format that is used in the communication sequences shown in FIGS. 3 to 6.

Each transmission frame includes a preamble for achieving modulation synchronism, a frame synchronization bit (unique word) for achieving frame synchronism, header information (including a communication frequency channel number, frame type, control frame type, frame sequence number, ACK/NACK information, data length, etc.), a header error detection bit, a header error correction bit, data (payload), a data error detection bit, and a data error correction bit.

The frame type, which is included in the header information, indicates whether the transmission frame is a beacon frame, control frame, or data frame. The control frame type represents detailed information about a frame that is classified by the frame type. If, for instance, the frame type indicates that the transmission frame is a control frame, the control frame type indicates whether the control frame is an entry frame for making a request for service entry, a control frame for connection, or a control frame for disconnection. The frame sequence number is a number that is assigned to a frame for providing sequence control. The ACK/NACK information is an information bit for notifying a remote station whether the data in a last-received frame is normally received. The host and terminal indicate the length of the data (payload) by using the data length, which is included in the header information, and notify a remote station of the length of the data. When the transmission frame is a beacon frame or control frame, a data area stores additional information that is to be conveyed to a remote station by using the frame. When the transmission frame is a data frame, on the other hand, the data area stores user data.

FIGS. 3 to 6 show various communication sequences that are followed by the wireless communication system according to the present embodiment. For the sake of convenience, each figure illustrates operations performed between a host and a terminal. However, if reflected wave transmission is performed in an environment where a plurality of hosts or a plurality of terminals exist, a frame transmitted from a host or terminal interrupts the communication of another host or terminal and makes it difficult to achieve data transmission unless all hosts and terminals exercise transmission/reception timing control.

If a plurality of hosts exist when the service entry sequence shown in FIG. 3 is followed, beacon frames transmitted from the hosts may collide with each other.

As such being the case, the present embodiment causes a host to perform a carrier sense on a communication frequency channel before the start of beacon frame transmission to judge whether the other hosts and terminals are engaged in communication. In accordance with the result of the carrier sense, the host starts transmitting a beacon frame on an idle communication frequency channel. If the communication frequency channel is busy, the host does not transmit a beacon frame. If the system includes a plurality of communication frequency channels, the host sequentially performs a carrier sense on all communication frequency channels and starts transmitting a beacon frame on an idle communication frequency channel. In this manner, control is exercised to ensure that the other hosts and terminals engaged in communication are not interrupted.

Further, if a plurality of terminals exist and are ready to receive a beacon frame from a host when the service entry sequence shown in FIG. 3 is followed, entry frames transmitted from the terminals may collide with each other. As such being the case, the terminals have a function for returning an entry frame with random timing. This function reduces the risk of entry frame collision by lowering the probability with which a plurality of terminals simultaneously transmit an entry frame.

When, in the service entry sequence, the host receives one or more entry frames and recognizes terminals ready for communication, the host selects one of such terminals as a connection target and connects to it. Meanwhile, if the host is not selected as a connection target by any terminal, the host may not receive an entry frame. If, in the latter case, a terminal selects another host as a connection target, the host performs a carrier sense before beacon frame transmission and recognizes that the communication frequency channel is busy due to the start of communication between the other host and the terminal. Therefore, the host can stop its beacon frame transmission.

When a terminal is not selected as a connection target by the host, the terminal loses an opportunity of transmitting an entry frame because the host, which has started communicating with another terminal, does not transmit a beacon frame. Therefore, the terminal does not interrupt the host and the other terminal that are engaged in communication.

A case where the host finishes communicating with the other terminal, resumes the service entry sequence, and connects to a terminal that was not selected as a connection target will now be described. To implement this case, the terminal, which was not initially selected as a connection target, has to constantly wait for a beacon frame from the host while the host is communicating with another terminal. It means that the power consumption for beacon frame reception is increased.

To solve the above problem, the host has a function for periodically transmitting a busy beacon after it starts communicating with a terminal. The busy beacon is used to announce that the host is communicating with a terminal, and distinguished from the beacon frame used in the service entry sequence. When a terminal that is not communicating with the host receives a busy beacon, the terminal subsequently waits to receive a busy beacon at intervals in accordance with interval information contained in the received busy beacon. This function reduces the power consumption for waiting to receive the busy beacon.

The terminal, which has the reflector, needs to receive a beacon frame and autonomously exercise timing control over transmission/reception to/from the host. Therefore, the terminal may additionally incorporate the following extended control functions depending on the type of transmission to the host and the form of terminal implementation:

### (1) Multiple beacon reception function for receiving all beacon frames transmitted from a plurality of hosts

### (2) Single beacon reception function for synchronizing with a host from which the first beacon frame was received and subsequently receiving only the beacon frame from that host

### (3) Specified beacon reception function for receiving only the beacon frame from a preregistered host

When, for instance, a terminal is in an environment in which the terminal can perform a push transmission to communicate with a plurality of hosts, the terminal can exercise the multiple beacon reception function to receive a beacon frame from the plurality of hosts, notify the user of the presence of the plurality of hosts, and let the user select a host to communicate with.

Further, if the employed implementation form is such that the reflector, which is used as a terminal, is mounted in a memory card (refer, for instance, to Japanese Patent Laid-Open No. 2006-216011), the terminal does not have a function for notifying the user of the status of reflected wave transmission. In other words, the terminal does not have a user interface for letting the user select one of the plurality of hosts from which the beacon frame was received. In this instance, the terminal exercises the single beacon reception function without confirming the user's intention to autonomously synchronize with a host from which the first beacon frame was received.

In addition, the terminal can incorporate the specified beacon reception function to exercise a simplified security function. For example, the terminal having the specified beacon reception function synchronizes with only the beacon frame received from a preregistered host and is not allowed to communicate with an unregistered host. Consequently, the use of this function ensures that the data retained by the terminal is not unduly accessed by an unspecified host.

Meanwhile, the host receives an entry frame within the service entry sequence to recognize a terminal that is ready for communication. However, the following two triggers may be used to select a connection target and make a connection to it:

### (1) Function for letting the user operate a host to select the terminal to be connected

### (2) Function for letting the user operate a terminal to issue a connection request to a host

In a “pull transmission” in which the former function is exercised, for instance, to read data from a terminal in accordance with a request from a host, the host notifies the user that connectable terminals exist, and allows the user to select one of such terminals. In response to a user selection, the host begins to connect to the selected terminal by following the connection request/connection response sequence shown in FIG. 3.

In a “push transmission” in which the latter function is exercised, for instance, to transfer data to a host in accordance with a request from a terminal, the terminal selects a host targeted for connection in accordance with a user operation and transmits an entry frame for notifying that there is transmission data (hereinafter may also be referred to as a “transmission-request-attached entry frame). Upon receipt of the transmission-request-attached entry frame, the host begins to connect to the terminal, which transmitted the entry frame, by following the connection request/connection request sequence shown in FIG. 3.

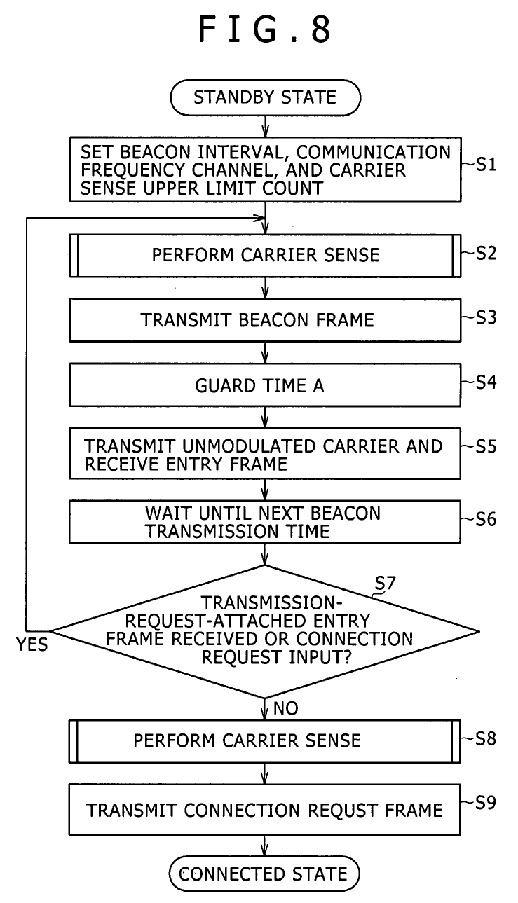

FIG. 8 is a flowchart illustrating a processing routine that a host in the wireless communication system according to the present embodiment performs to control the service entry sequence.

The protocol control section 121 of the host is in a standby state after power-on. When the protocol control section 121 receives a beacon transmission request from the host function section 13, the processing routine starts.

In accordance with the beacon transmission request, the protocol control section 121 sets a beacon interval, a carrier sense upper limit count, and the communication frequency channel for use in the RF function section 11 (step S1). The carrier sense upper limit count is used for channel switching. The number of times the carrier sense has found a busy communication frequency channel is counted. If the carrier sense upper limit count is exceeded, a switch is made to another communication frequency channel.

Next, the protocol control section 121 of the host performs a carrier sense (step S2). The processing procedure for a carrier sense will be described later.

If the RF function section 11 does not receive a radio wave having a predetermined or greater electric field strength during a carrier sense period, the protocol control section 121 generates a beacon frame and transmits an ASK modulated wave of the beacon frame via the modulation function section 122 and RF function section 11 (step S3).

Next, the protocol control section 121 of the host stands by for guard time A, which is requisite to start a frame transmission after beacon frame reception by a terminal (step S4), and then provides an entry period. During the entry period, the protocol control section 121 controls the RF function section 11 to transmit an unmodulated carrier and begins to receive an entry frame.

Upon receipt of an entry frame during the entry period (step S5), the protocol control section 121 notifies the host function section 13 of such entry frame reception, and via a user interface or the like, furnishes the user with information about a terminal that has transmitted the entry frame.

When the entry period elapses, the protocol control section 121 waits until the next beacon transmission time, which is set in accordance with the beacon interval (step S6). When the next beacon transmission time comes, the protocol control section 121 judges whether a transmission-request-attached entry frame was received during the last entry frame reception period or a connection request is received from the host function section 13 (step S7).

If no transmission-request-attached entry frame was received or the connection request for connecting to a terminal that has transmitted the received entry frame is not received from the host function section 13 (if the query in step S7 is answered “No”), processing returns to step S2. In step S2, a carrier sense is performed to prepare for the next beacon transmission time.

If a transmission-request-attached entry frame was received and the connection request for connecting to a terminal that has transmitted such an entry frame is received from the host function section 13 or a transmission-request-attached entry frame is received (if the query in step S7 is answered “Yes”), the protocol control section 121 performs a carrier sense (step S8), transmits a connection request frame to the terminal to which the connection request was issued from the host function section 13 (step S9), and subsequently connects to the terminal.

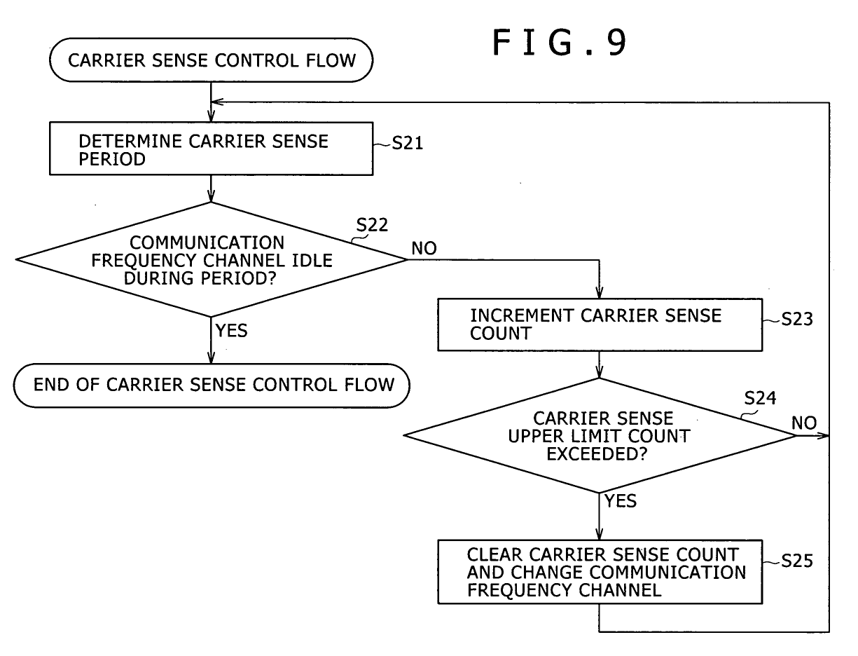

FIG. 9 is a flowchart illustrating a carrier sense control procedure that the protocol control section 121 of the host performs in steps S2 and S8, which are shown in the flowchart in FIG. 8.

First of all, the protocol control section 121 determines a carrier sense period (step S21).

The carrier sense period is defined as the sum of guard time and random backoff time. The guard time, which is a system-specific value, is either guard time A or guard time B, whichever is longer. Guard time A is a period of time that is necessary for performing a frame transmission after frame reception by a terminal. Guard time B is a period of time that is necessary for performing a frame transmission after frame reception by a host. The random backoff time is a period of time that is randomly set. In other words, the carrier sense period is determined by adding a randomly defined period of time to a period of time that is equal to or longer than the maximum period of time during which the terminal and host that have started communicating with each other do not perform any transmission. The carrier sense period is determined as described above to reduce the possibility of beacon frame transmissions from a plurality of hosts colliding with each other.

The protocol control section 121 exercises control so that the RF function section 11 starts a reception operation (carrier sense) on a communication frequency channel (step S22).

If the RF function section 11 receives a radio wave having a predetermined or greater electric field strength during the carrier sense period (if the query in step S22 is answered “No”), the carrier sense count is incremented (step S23) to judge whether the carrier sense upper limit count is exceeded (step S24).

If the carrier sense upper limit count is not exceeded by the carrier sense count reached on the current communication frequency channel, the protocol control section 121 of the host determines the backoff time randomly again, returns to step S21, determines the carrier sense period, and performs a carrier sense (step S22).

If, on the other hand, the carrier sense upper limit count is exceeded, step S25 is performed to clear the carrier sense count to zero and set a communication frequency channel again. Subsequently, processing returns to step S21. After the carrier sense period is determined in step S21, a carrier sense is performed (step S22).

If the RF function section 11 does not receive a radio wave having a predetermined or greater electric field strength during the carrier sense period (if the query in step S22 is answered “Yes”), the protocol control section 121 terminates a carrier sense control flow, generates a beacon frame, and transmits an ASK modulated wave of the beacon frame via the modulation function section 122 and RF function section 11 (as described earlier).

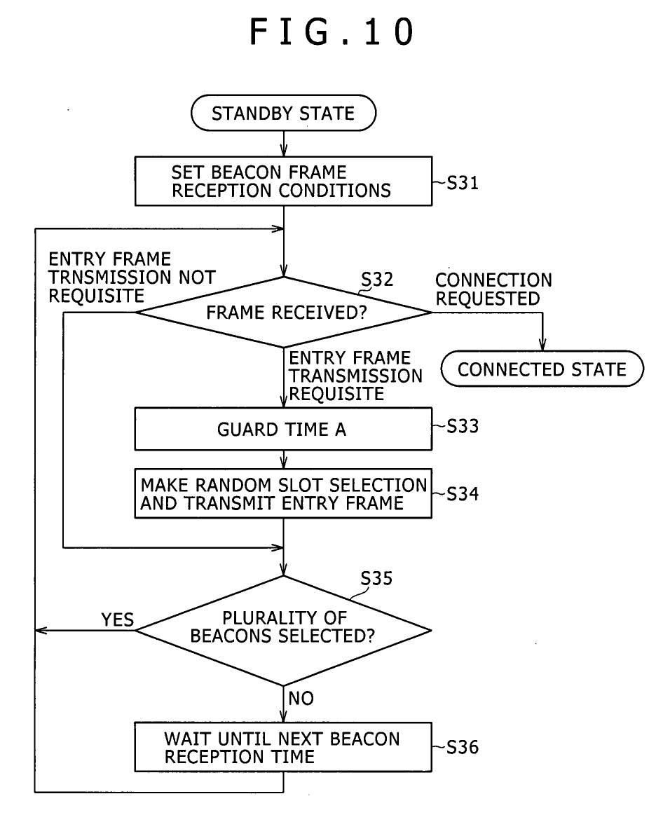

FIG. 10 is a flowchart illustrating how a terminal in the wireless communication system according to the present embodiment exercises service entry sequence control.

The protocol control section 221 of the terminal is in a standby state after power-on. Upon receipt of a beacon reception request from the terminal function section 23, the protocol control section 221 defines beacon frame reception conditions by selecting a multiple beacon reception mode, a single beacon reception mode, or a specified beacon reception mode (step S31).

A setting for the beacon frame reception conditions may be preset in a memory (not shown) in the protocol control section 221 or entered together with an instruction for the beacon reception request from the user interface of the terminal function section 23. If a memory card or other similar terminal without the terminal function section 23 is used, the beacon frame reception conditions are automatically determined after power-on in accordance with a value that is preset in the memory in the protocol control section 221. The setting for the beacon frame reception conditions, which is stored in the memory in the protocol control section 221, can be rewritten from the outside of the terminal.

After determining the beacon frame reception conditions, the protocol control section 221 of the terminal makes the RF function section 21 ready for reception. Upon receipt of a frame, the protocol control section 221 confirms a header of the received frame to determine the type of the frame (step S32).

If the received frame is recognized as a beacon frame, the protocol control section 221 judges in accordance with the beacon frame reception conditions whether the received beacon frame is requisite and whether an entry frame is requisite.

If the multiple beacon reception mode is selected to define the beacon frame reception conditions, the beacon interval and host information contained in the received beacon frame are both cached as a pair. It is then judged that the transmission of an entry frame is requisite. Consequently, processing proceeds to a subsequent operation for transmitting an entry frame to a host that has transmitted the beacon frame.

If the single beacon reception mode is selected to define the beacon frame reception conditions, the beacon interval and host information contained in the received beacon frame are both cached as a pair. Subsequently, the beacon frame reception conditions are changed to select the specified beacon reception mode, which permits a beacon frame reception from only a host that has transmitted the beacon frame. It is then judged that the transmission of an entry frame is requisite. Consequently, processing proceeds to a subsequent operation for transmitting an entry frame to the host that has transmitted the beacon frame.

If the specified beacon reception mode is selected to define the beacon frame reception conditions, a check is performed to judge whether the received beacon frame has been transmitted from a specified host. If not, it is concluded that the transmission of an entry frame is not requisite. Therefore, the received beacon frame is discarded to continue receiving a frame. If, on the other hand, the received beacon frame has been transmitted from the specified host, it is judged that the transmission of an entry frame is requisite. Thus, the beacon interval and host information contained in the received beacon frame are both cached as a pair. Consequently, processing proceeds to a subsequent operation for transmitting an entry frame to the host that has transmitted the beacon frame.

If the result of the judgment of the received beacon frame indicates that the transmission of an entry frame is requisite, the protocol control section 221 waits until guard time A, which is necessary for performing a frame transmission after frame reception by a terminal, elapses (step S33), randomly selects one of a plurality of entry slots, and transmits an entry frame to the host that has transmitted the beacon frame (step S34). If the terminal function section 23 has notified the protocol control section 221 that there is transmission data, the protocol control section 221 transmits a transmission-request-attached entry frame (described earlier).

If the multiple beacon reception mode is selected to define the beacon frame reception conditions (if the query in step S35 is answered “Yes”), the protocol control section 221 returns to step S32 immediately after an entry frame transmission, and makes the RF function section 21 ready again for reception for the purpose of receiving the next beacon frame within the same beacon interval.

If the specified beacon reception mode is selected (if the query in step S35 is answered “No”), the protocol control section 221 stands by for the beacon interval in accordance with the beacon interval information contained in the received beacon frame (step S36), returns to step S32, and makes the RF function section 21 ready again for reception for the purpose of receiving a beacon frame during the next beacon interval. If the terminal is initially placed in the single beacon reception mode, it switches to the specified beacon reception mode upon receipt of a beacon frame. Therefore, the terminal similarly stands by for the beacon interval, returns to step S32, and becomes ready for reception.

If the host is communicating with a terminal, the host may transmit a busy beacon, instead of a normal beacon frame, at beacon intervals to indicate that it is engaged in communication (as described earlier). If the terminal receives a busy beacon in step S32, it does not have to transmit an entry frame. Therefore, the terminal skips steps S33 and S34, which are performed to transmit an entry name. Further, the protocol control section 221 judges in accordance with the beacon frame reception conditions whether the received beacon frame is requisite, as in cases where a normal beacon frame is received.

If the multiple beacon reception mode is selected to define the beacon frame reception conditions, the protocol control section 221 caches the beacon interval and host information contained in the received busy beacon as a pair. The protocol control section 221 returns to step S32 immediately after an entry frame transmission (when the query in step S35 is answered “Yes”), and makes the RF function section 21 ready again for reception for the purpose of receiving the next beacon frame within the same beacon interval.

If the single beacon reception mode is selected to define the beacon frame reception conditions (if the query in step S35 is answered “No”), the protocol control section 221 stands by for the beacon interval in accordance with the beacon interval information contained in the received busy beacon (step S36), returns to step S32, and makes the RF function section 21 ready again for reception for the purpose of receiving a beacon frame during the next beacon interval. In this instance, the protocol control section 221 caches the beacon interval and host information contained in the received busy beacon as a pair. Further, the protocol control section 221 switches to the specified beacon reception mode to define the subsequent beacon frame reception conditions for the purpose of permitting a beacon frame reception from only a host that has transmitted the beacon frame.

If the specified beacon reception mode is selected to define the beacon frame reception conditions, the protocol control section 221 judges whether the received busy beacon has been transmitted from a specified host. If not (if the query in step S35 is answered “No”), the protocol control section 221 discards the received busy beacon, returns to step S32, and makes the RF function section 21 ready again for reception for the purpose of receiving a beacon frame during the next beacon interval. If, on the other hand, the received busy beacon has been transmitted from the specified host, the protocol control section 221 caches the beacon interval and host information contained in the received busy beacon as a pair. Further, the protocol control section 221 stands by for the beacon interval in accordance with the beacon interval information contained in the received busy beacon (step S36), returns to step S32, and makes the RF function section 21 ready again for reception for the purpose of receiving a beacon frame during the next beacon interval.

Further, when a terminal confirms the type of a received frame in step S32 and finds that the received frame is a connection request frame addressed to the terminal, the terminal connects to a host that has transmitted the connection request frame (step S37).

After the host and terminal are connected, they transmit/receive variable-length frames. The variable-length frame exchange sequence based on reflected wave transmission is not described in detail in this document because it can use a method disclosed, for instance, by Japanese Patent Laid-Open No. 2007-110611, which is already assigned to the applicant of the present invention.

No matter what frame exchange sequence is applied, the host is provided with a function for transmitting a busy beacon to indicate that the host is connected to a terminal, and the terminal is provided with a function for receiving the busy beacon. The busy beacon is periodically transmitted subsequently to a beacon interval during which the beacon frame and connection request frame were transmitted. In this instance, the host transmits the busy beacon without performing a carrier sense. This is performed to prevent another host from transmitting a beacon frame during the carrier sense period.

While the host and terminal are connected, they need to ensure that outgoing frames do not collide with a busy beacon. As such being the case, the host calculates the transmission time necessary for an outgoing frame when it is about to transmit the frame. If the calculated transmission time overlaps with busy beacon transmission time, the host temporarily suspends the transmission of the frame, and transmits the suspended frame after the elapse of the busy beacon transmission time.

When connected to the host, the terminal uses the cached beacon interval and host information to recognize busy beacon reception time. When the terminal is about to transmit a frame, the terminal calculates the transmission time necessary for the outgoing frame, as is the case with the host. If the calculated transmission time overlaps with busy beacon transmission time, the terminal temporarily suspends the transmission of the frame and receives a busy beacon. After the receipt of the busy beacon, the terminal transmits the suspended frame.

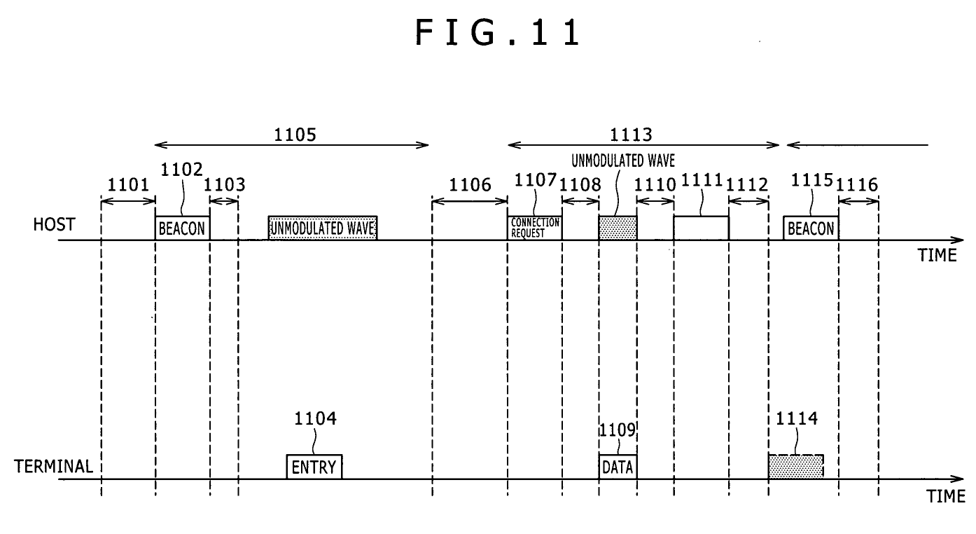

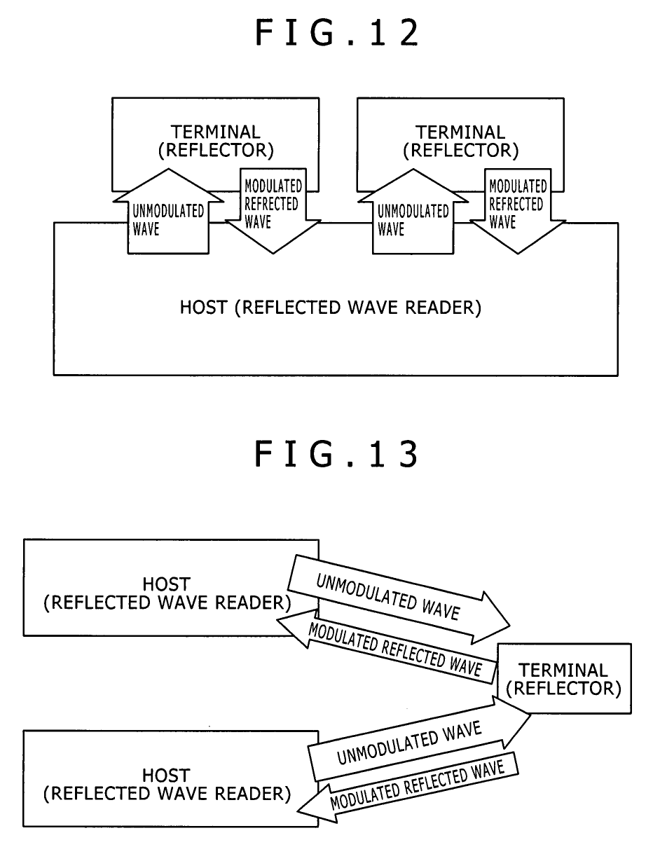

FIG. 11 shows a typical frame exchange sequence that is followed when a host communicating with a terminal uses a function for periodically transmitting a busy beacon for announcement purposes.

First of all, the host receives a beacon transmission request and performs a carrier sense (1101). If the communication frequency channel is idle, the host transmits a beacon frame 1102. An entry period is provided after the beacon frame transmission. The host continuously transmits an unmodulated carrier during the entry period so that the terminal can transmit an entry frame by means of reflected wave transmission.

Upon receipt of a beacon reception request, the terminal becomes ready for frame reception. If a received beacon frame 1102 agrees with the beacon reception conditions, the terminal randomly selects a slot when predetermined guard time A (1103) elapses after the receipt of the beacon frame 1102, and uses the unmodulated carrier, which is transmitted from the host, to transmit an entry frame 1104 by means of reflected wave transmission.

When the host receives the entry frame 1104 from the terminal and starts connecting to the terminal, the host performs a carrier sense (1106) with beacon interval timing 1105. If the communication frequency channel is idle, the host transmits a connection request frame 1107 to the terminal to be connected.

Upon receipt of the connection request frame, the terminal calculates data transmission time from the length of a transmission frame, and judges whether a transmission can be completed within the beacon interval 1113. If it is judged that the transmission can be carried out, the terminal transmits a data frame 1109 when guard time A (1108) elapses after the receipt of the connection request frame.

Upon receipt of the data frame 1109 from the terminal, the host calculates data transmission time from transmission frame length after the elapse of guard time B (1110), and judges whether a transmission can be completed within the beacon interval 1113. If it is judged that the transmission can be carried out, the host transmits a frame 1111 when guard time B elapses after the receipt of the data frame 1109.

As described above, the host and terminal exchange variable-length frames. If it is judged that the transmission frame may not be completely transmitted within the beacon interval 1113, the transmission of the transmission frame is temporarily suspended (1114). Subsequently, the host connected to the terminal waits until the beacon interval 1113 elapses, and transmits a busy beacon 1115 without performing a carrier sense. Meanwhile, the terminal transmits a frame when guard time A (1116) elapses after the receipt of the busy beacon. If the transmission of any transmission frame is temporarily suspended due to the busy beacon, the terminal transmits such a frame 1117 with this timing.

While the present invention has been described in detail in conjunction with specific embodiments, persons of skill in the art will appreciate that variations may be made without departure from the scope and spirit of the present invention. The described embodiments are to be considered in all respects only as illustrative and not restrictive. The scope of the invention is, therefore, indicated by the appended claims rather than by the foregoing description.

What is claimed is:

1. A wireless communication system comprising:
a terminal including a reflector that receives an unmodulated carrier and transmits a modulated reflected wave on which data is superimposed; and
a host including a reflected wave reader that reads data from the modulated reflected wave;
wherein the host periodically transmits a beacon frame and successively transmits an unmodulated carrier during an entry period that is provided after beacon frame transmission, and
upon receipt of the beacon frame from the host, the terminal returns an entry frame that is superimposed on a reflected wave of the unmodulated carrier received during the entry period.

2. The wireless communication system according to claim 1, wherein the host writes host information that includes the information about a communication frequency channel for use with the beacon frame and a unique ID of the host,
when the terminal receives the beacon frame and intends to connect to the host, which has transmitted the beacon frame, the terminal writes a unique ID of the terminal, settable communication parameters, and other information in the entry frame, and
the host acquires information about the terminal in accordance with the information written in the entry frame, transmits a connection request frame to the terminal to be connected, receives a connection response frame that is returned from the terminal in response to the connection request frame, and establishes a host-to-terminal communication connection.

3. The wireless communication system according to claim 2, wherein
the host starts transmitting the beacon frame on an idle communication frequency channel after a carrier sense is performed, and
the terminal returns the entry frame with random timing after receipt of the beacon frame.

4. The wireless communication system according to claim 3, wherein, when the host may not receive the entry frame during an entry period subsequent to beacon frame transmission and recognizes through the carrier sense before beacon frame transmission that the communication frequency channel has become busy due to the start of communication between another host and a terminal, the host stops transmitting the beacon frame.

5. The wireless communication system according to claim 3, wherein,
while communicating with a terminal, the host periodically transmits a busy beacon for reporting the communication with the terminal, and
a terminal not communicating with the host waits to receive the busy beacon at intervals in accordance with interval information contained in the busy beacon.

6. The wireless communication system according to claim 1, wherein
the terminal has a multiple beacon reception function for receiving all beacon frames transmitted from a plurality of hosts and returning the entry frame, and
a host receiving the entry frame chooses to communicate with the terminal.

7. The wireless communication system according to claim 1, wherein the terminal has a single beacon reception function for synchronizing with a host from which the first beacon frame was received and subsequently receiving only the beacon frame from the host.

8. The wireless communication system according to claim 1, wherein the terminal has a specified beacon reception function for receiving only the beacon frame from a preregistered host and returning the entry frame.

9. The wireless communication system according to claim 1, wherein a host receiving the entry frame from one or more terminals begins to communicate with a user-selected terminal.

10. The wireless communication system according to claim 1, wherein
the terminal selects a user-operated connected host and transmits a transmission-request-attached entry frame for notifying that there is transmission data, and
upon receipt of the transmission-request-attached entry frame, the host starts connecting to the terminal that has issued the request attached to the entry frame.

11. A wireless communication apparatus that transmits an unmodulated carrier to a terminal having a reflector and includes a reflected wave reader for reading a modulated reflected wave signal that is obtained by superimposing data on a reflected wave of the unmodulated carrier from the terminal, the wireless communication apparatus comprising:
beacon frame transmitting means for transmitting a beacon frame periodically; and
entry frame receiving means for waiting for an entry frame that is superimposed on a modulated reflected wave from the terminal in a situation where the unmodulated carrier is successively transmitted during an entry period provided after a beacon frame transmission.

12. The wireless communication apparatus according to claim 11, further comprising:
connection controlling means for transmitting a connection request frame to the terminal to be connected, and establishing a host-to-terminal communication connection when a connection response frame is returned from the terminal in response to the connection request frame;
wherein the beacon frame transmitting means writes host information that includes the information about a communication frequency channel for use with the beacon frame and a unique ID of a host, and
the entry frame receiving means acquires information about the terminal in accordance with the information written in the entry frame.

13. The wireless communication apparatus according to claim 12, wherein the beacon frame transmitting means starts transmitting the beacon frame on an idle communication frequency channel after a carrier sense is performed.

14. The wireless communication apparatus according to claim 13, wherein, when the beacon frame transmitting means may not receive the entry frame during the entry period and recognizes through the carrier sense before beacon frame transmission that the communication frequency channel has become busy due to the start of communication between another host and a terminal, the beacon frame transmitting means stops transmitting the beacon frame.

15. The wireless communication apparatus according to claim 13, wherein, while communication is established with a terminal, the beacon frame transmitting means periodically transmits a busy beacon for reporting the communication with the terminal.

16. The wireless communication apparatus according to claim 12, wherein the connection controlling means starts connecting to a user-selected terminal.

17. A wireless communication apparatus for transmitting a modulated reflected wave signal that is obtained by superimposing data on a reflected wave of an unmodulated carrier from a host having a reflected wave reader, the wireless communication apparatus comprising:
beacon frame receiving means for receiving a beacon frame that is periodically transmitted from a host; and
entry frame transmitting means for transmitting an entry frame that is superimposed on a reflected wave of an unmodulated carrier transmitted from the host during an entry period provided after a beacon frame transmission.

18. The wireless communication apparatus according to claim 17, further comprising:
connection controlling means for returning a connection response frame in response to a connection request frame transmitted from the host and establishing a communication connection to the host;
wherein the beacon frame contains written host information that includes the information about a communication frequency channel used by the host and a unique ID of the host, and
when the host transmitting the beacon frame is to be connected, the entry frame transmitting means writes a unique ID of a terminal, settable communication parameters, and other information in the entry frame.

19. The wireless communication apparatus according to claim 18, wherein the entry frame transmitting means returns the entry frame with random timing after receipt of the beacon frame.

20. The wireless communication apparatus according to claim 19, wherein
a host communicating with another terminal periodically transmits a busy beacon for reporting a communication state, and
the beacon frame receiving means waits to receive the busy beacon at intervals in accordance with interval information contained in the busy beacon.

21. The wireless communication apparatus according to claim 17, wherein the beacon frame receiving means has a multiple beacon reception function for receiving all beacon frames transmitted from a plurality of hosts and returning the entry frame to each of the plurality of hosts.

22. The wireless communication apparatus according to claim 17, wherein the beacon frame receiving means has a single beacon reception function for synchronizing with a host from which the first beacon frame was received and subsequently receiving only the beacon frame from the host.

23. The wireless communication apparatus according to claim 17, wherein the beacon frame receiving means has a specified beacon reception function for receiving only the beacon frame from a preregistered host and returning the entry frame.

24. A wireless communication apparatus that transmits an unmodulated carrier to a terminal having a reflector and includes a reflected wave reader for reading a modulated reflected wave signal that is obtained by superimposing data on a reflected wave of the unmodulated carrier from the terminal, the wireless communication apparatus comprising:
a beacon frame transmitter configured to transmit a beacon frame periodically; and
an entry frame receiver configured to wait for an entry frame that is superimposed on a modulated reflected wave from the terminal in a situation where the unmodulated carrier is successively transmitted during an entry period provided after a beacon frame transmission.

25. A wireless communication apparatus for transmitting a modulated reflected wave signal that is obtained by superimposing data on a reflected wave of an unmodulated carrier from a host having a reflected wave reader, the wireless communication apparatus comprising:
a beacon frame receiver configured to receive a beacon frame that is periodically transmitted from a host; and
an entry frame transmitter configured to transmit an entry frame that is superimposed on a reflected wave of an unmodulated carrier transmitted from the host during an entry period provided after a beacon frame transmission.
